(19) United States
(12) Patent Application Publication
(10) Pub. No.: US 2009/0009511 A1
(43) Pub. Date: Jan. 8, 2009

(54) IMAGE-DATA DISPLAY SYSTEM, IMAGE-DATA OUTPUT DEVICE, AND IMAGE-DATA DISPLAY METHOD

(76) Inventors: Toru UEDA, Kyoto (JP); Masafumi Hirata, Tokyo (JP); Masahiro Chiba, Nara-shi (JP); Satoshi Yoshikawa, Narashino-shi (JP); Aya Enatsu, Chiba-shi (JP); Natsuki Yuasa, Yachiyo-shi (JP); Tetsuya Matsuyama, Ichikawa-shi (JP)

Correspondence Address: BIRCH STEWART KOLASCH & BIRCH, PO BOX 747, FALLS CHURCH, VA, 22040-0747, US

(21) Appl. No.: 12/166,175

(22) Filed: Jul. 1, 2008

(30) Foreign Application Priority Data
Jul. 5, 2007 (JP) 2007-177312

(51) Int. Cl. G06T 15/00

(52) U.S. Cl. 345/419

(57) ABSTRACT

An image-data display system includes: a display-related-information acquiring unit that acquires a display size of an object image including a plane projection image of a three-dimensional object; an output-image-data generating unit that acquires instruction image data indicative of two positions in the plane projection image displayed in the object image, a length between the two positions being actual size when the object image is displayed according to the display size; and a display device that displays the object image according to the display size, and executes display processing based on the instruction image data.

### BACKGROUND OF THE INVENTION

1. Field of the Invention

The present invention relates to an image-data display system, an image-data output device, and an image-data display method.

Priority is claimed on Japanese Patent Application No. 2007-177312, filed Jul. 5, 2007, the content of which is incorporated herein by reference.

2. Description of the Related Art

All patents, patent applications, patent publications, scientific articles, and the like, which will hereinafter be cited or identified in the present application, are incorporated by reference in their entirety in order to describe more fully the state of the art to which the present invention pertains.

Recently, online shopping is widespread due to the popularization of online services. Compared with normal stores that actually display and sell products, the online shopping has advantages in that many more products can be stored and the price thereof can be reduced.

On the other hand, online shopping has disadvantages in that real products cannot be seen and touched, causing buyer misunderstanding of the size of the real product. Therefore, problems are caused when the size of a purchased and sent product is different from what was expected.

As one method of making up for the disadvantages, it can be considered to display the actual-size products. Due to the necessity of a relatively large display, the display in actual size has seldom been discussed about seriously, conventionally. Recently, however, large-sized display devices such as large-sized liquid-crystal displays have been developed, and an increasing number of users buy 50-inch or larger flat-panel TVs at home. Therefore, display in actual size has been becoming realistic.

A technique of display in actual size is disclosed in Japanese Unexamined Patent Application, Fast Publication, No. 2003-219372. In this technique, display in actual size is implemented by enlarging and reducing target image data with a ratio determined by the size and the aspect ratio of a screen, and the standard display size of the target image data.

However, the display in actual size might cause more misunderstanding. In other words, when an image of a three-dimensional object is displayed in actual size on a two-dimensional display, there necessarily becomes a portion whose size differs from that of the real object. For example, in a perspective view showing a three-dimensional object, the depth thereof does not become actual size when the width thereof is set to be actual size. Since the reduction ratio of an object differs according to the distance from a camera, when the length of a portion that is one of elements constituting a three-dimensional object and positioned far from the camera is set to be actual size, the length of another portion close to the camera does not become actual size. In the conventional technique of the display in actual size, a user might wrongly assume what is not displayed in actual size as being displayed in actual size.

### SUMMARY OF THE INVENTION

Therefore, an object of the present invention is to provide an image-data display system, an image-data output device, and an image-data display method for clearly specifying an actual-size portion upon displaying a three-dimensional object on a two-dimensional display.

In accordance with an aspect of the present invention, an image-data display system includes: a display-size acquiring unit that acquires a display size of an object image including a plane projection image of a three-dimensional object; an instruction-image-data acquiring unit that acquires instruction image data indicative of two positions in the plane projection image displayed in the object image, a length between the two positions being actual size when the object image is displayed according to the display size; and a display device that displays the object image according to the display size, and executes display processing based on the instruction image data.

Accordingly, when an image of a three-dimensional object is displayed in actual size on a two-dimensional display, an actual-size portion can be clearly specified by an instruction image.

Additionally, in the image-data display system, the instruction image data may include data indicative of an actual-size length between the two positions.

Accordingly, a user viewing the image displayed by the display device can recognize the length of the portion specified by the data.

Furthermore, in the image-data display system, the display device may enlarge or reduce the object image to the display size.

Accordingly, an actual-size display can be implemented by an output of the display size to the display device.

Moreover, the image-data display system may further include an output-image generating unit that controls a dot size of the object image based on the display size and a dot pitch of a display surface of the display device, and the display device may display the object dot by dot.

Accordingly, since the dot size of the object image can be determined so that the object image is displayed according to the display size when the object image is displayed dot by dot by the display device, the actual size display can be implemented when the display device that executes the dot-by-dot display.

In accordance with another aspect of the present invention, an image-data output device includes: a display-size acquiring unit that acquires a display size of an object image including a plane projection image of a three-dimensional object; an instruction-image-data acquiring unit that acquires instruction image data indicative of two positions in the plane projection image displayed in the object image, a length between the two positions being actual size when the object image is displayed according to the display size; and an output unit that outputs, to a display device, the object image, the instruction image data, and the display size.

In accordance with another aspect of the present invention, an image-data output device includes: a display-size acquiring unit that acquires a display size of an object image including a plane projection image of a three-dimensional object; an instruction-image-data acquiring unit that acquires instruction image data indicative of two positions in the plane projection image displayed in the object image, a length between the two positions being actual size when the object image is displayed according to the display size; a dot-size control unit that controls a dot size of the object image based on the display size and a dot pitch of a display surface of a display device; and an output unit that outputs, to the output device, the object image after the control by the dot-size control unit and the instruction image data.

In accordance with another aspect of the present invention, an image-data output device includes: a display-size acquiring unit that acquires a display size of an object image including a plane projection image of a three-dimensional object; an instruction-image-data acquiring unit that acquires instruction image data indicative of two positions in the plane projection image displayed in the object image, a length between the two positions being actual size when the object image is displayed according to the display size; a dot-size control unit that controls a dot size of the object image based on the display size and a dot pitch of a display surface of a display device; an output unit that outputs the object image after the control by the dot-size control unit to a first memory, and an instruction image generated based on the instruction image data to a second memory; and an image combining unit that combines the object image stored in the first memory and the instruction image stored in the second memory.

In accordance with another aspect of the present invention, an image-data output device includes: a print-size acquiring unit that acquires a print size of an object image including a plane projection image of a three-dimensional object; an instruction-image-data acquiring unit that acquires instruction image data indicative of two positions in the plane projection image displayed in the object image, a length between the two positions being actual size when the object image is displayed according to the print size; a dot-size control unit that controls a dot size of the object image based on the print size and a resolution of a printer; and an output unit that outputs, to the printer, the object image after the control by the dot-size control unit and the instruction image data.

In accordance with another aspect of the present invention, an image-data display method includes: acquiring a display size of an object image including a plane projection image of a three-dimensional object; acquiring instruction image data indicative of two positions in the plane projection image displayed in the object image, a length between the two positions being actual size when the object image is displayed according to the display size; displaying the object image according to the display size; and executing display processing based on the instruction image data.

In accordance with another aspect of the present invention, a recording medium stores a program causing a computer to execute: acquiring a display size of an object image including a plane projection image of a three-dimensional object; acquiring instruction image data indicative of two positions in the plane projection image displayed in the object image, a length between the two positions being actual size when the object image is displayed according to the display size; and outputting, to a display device, the object image, the instruction image data, and the display size.

In accordance with another aspect of the present invention, a recording medium that stores a program causing a computer to execute: acquiring a display size of an object image including a plane projection image of a three-dimensional object; acquiring instruction image data indicative of two positions in the plane projection image displayed in the object image, a length between the two positions being actual size when the object image is displayed according to the display size; controlling a dot size of the object image based on the display size and a dot pitch of a display surface of a display device; and outputting, to the display device, the object image after the control by the dot-size control unit and the instruction image data.

### BRIEF DESCRIPTION OF THE DRAWINGS

Objects, features, aspects, and advantages of the present invention will become apparent to those skilled in the art from the following detailed descriptions taken in conjunction with the accompanying drawings, illustrating the embodiments of the present invention, in which:

FIG. 1 is a block diagram showing a system configuration of an image-data display system according to a first embodiment of the present invention;

FIG. 2 is a block diagram showing a detailed configuration of an image-data output device according to the first embodiment of the present invention;

FIG. 3 is a flowchart showing a processing flow of the image-data output device according to the first embodiment of the present invention;

FIGS. 4A, 4B, 4C, and 4D are schematic views showing an example of an object image according to the first embodiment of the present invention;

FIG. 5 shows an example of output image data according to the first embodiment of the present invention;

FIG. 6 is a schematic view showing an operation of a display device according to the first embodiment of the present invention;

FIGS. 7A, 7B, 7C, and 7D are schematic views showing an example of a display screen of a server device by executing an authoring tool according to the first embodiment of the present invention;

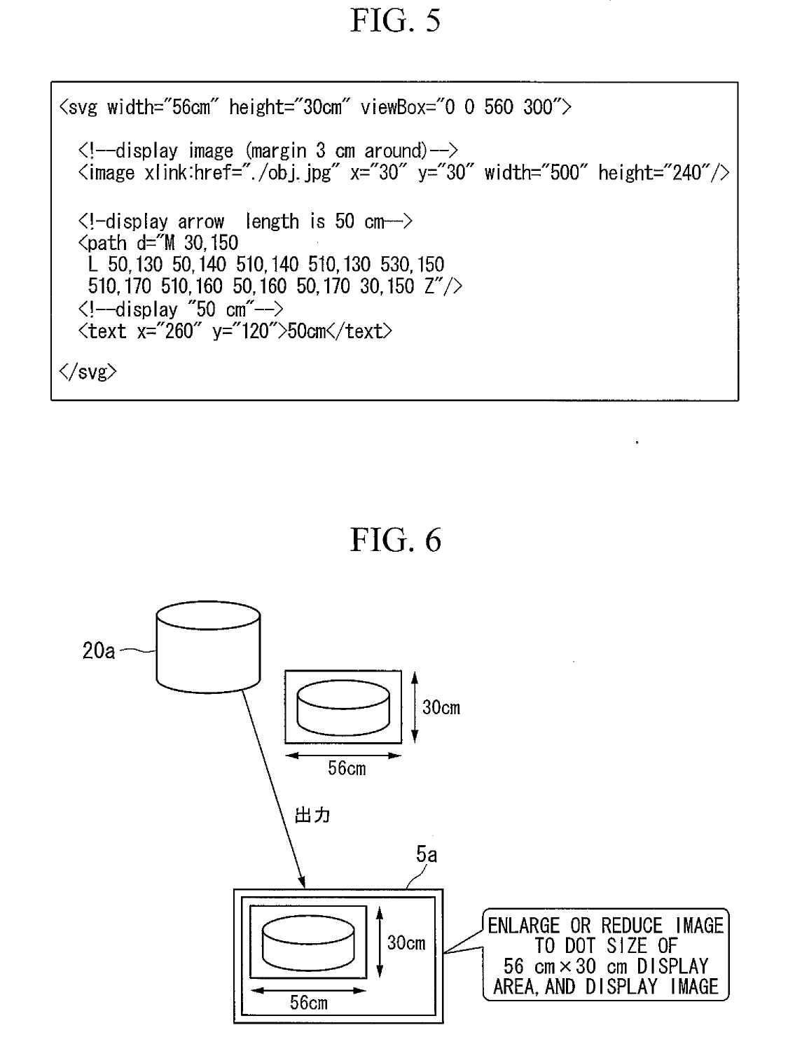

FIGS. 5A and 8B are schematic views showing an example of a display screen of the server device by executing the authoring tool according to the first embodiment of the present invention;

FIG. 9 is a block diagram showing a system configuration of an image-data display system according to a second embodiment of the present invention;

FIG. 10 is a block diagram showing a detailed configuration of an image-data output device and a display device according to the second embodiment of the present invention;

FIG. 11 is a schematic view showing operations of a dot-size control by an output-image-data generating unit and a display by an image-data display unit according to the second embodiment of the present invention;

FIG. 12 is a schematic view showing an operation of an image-data output device according to a third embodiment of the present invention;

FIG. 13 is a block diagram showing a hardware configuration of the image-data output device according to the third embodiment of the present invention;

FIG. 14 is a flowchart showing a processing flow of processing for displaying an object image among processing executed by the image-data output device according to the third embodiment of the present invention;

FIG. 15 is a flowchart showing a processing flow of processing for displaying the object image among the processing executed by the image-data output device according to the third embodiment of the present invention;

FIG. 16 is a schematic view showing examples of a graphic plane, an OSD plane, and a displayed image according to the third embodiment of the present invention;

FIG. 17 is a schematic view showing a specific example of a fourth embodiment of the present invention;

FIG. 18 is a schematic view showing processing of an image-data output device according to the fourth embodiment of the present invention;

FIG. 19 is a schematic view showing an example of an HTML image displayed by a display device according to a fifth embodiment of the present invention;

FIGS. 20A, 20B, and 20C are schematic views showing a specific example of the fifth embodiment of the present invention;

FIGS. 21A and 21B are schematic views showing a specific example of a sixth embodiment of the present invention;

FIGS. 22A and 22B are schematic views showing a case in which a watch is displayed in actual size in a seventh embodiment of the present invention;

FIGS. 23A, 231B, and 23C are schematic views showing a plane projection image of a chair according to an eighth embodiment of the present invention that is shot at the front;

FIGS. 24A and 24B are schematic views showing a case in which a car is displayed on a display device having a screen larger than a actual-size car in a ninth embodiment of the present invention;

FIG. 25 is a schematic view showing an example of a printer output of an image-data output device according to a tenth embodiment of the present invention; and

FIG. 26 is a schematic view showing a case in which a cellular phone according to an eleventh embodiment of the present invention generates an output image data corresponding to an object image displayed on a screen thereof, and transmits the generated output image data to a TV.

### DETAILED DESCRIPTION OF THE INVENTION

With reference to the accompanying drawings, exemplary embodiments of the present invention are explained below.

### First Embodiment

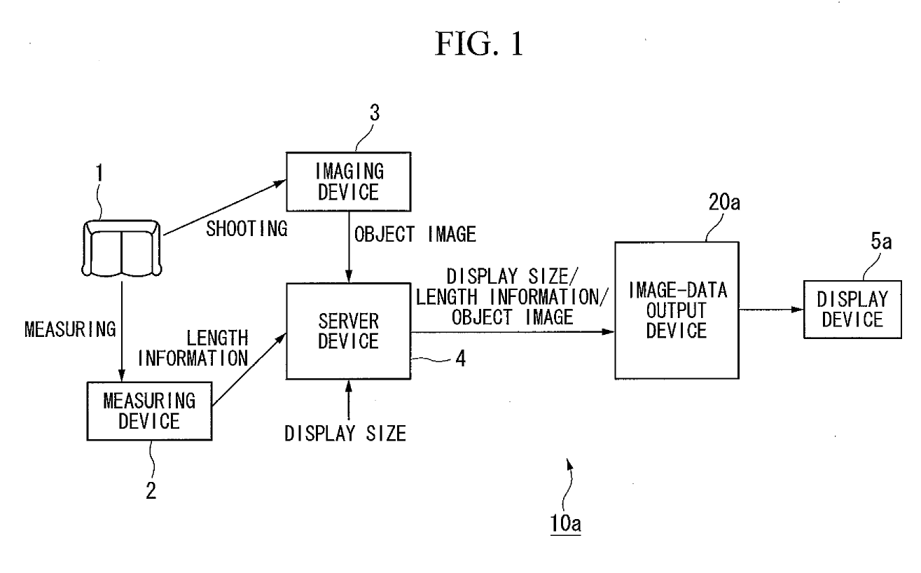

FIG. 1 shows a system configuration of an image-data display system 10a according to a first embodiment of the present invention. As shown in FIG. 1, the image-data display system 10a includes a measuring device 2, an imaging device 3, a server device 4, a display device 5a, and an image-data output device 20a.

The measuring device 2 measures the length of an object 1 (a sofa, a cheesecake, a bicycle, an umbrella, a ring, etc.) that is an object having a three-dimensional configuration. More specifically, the measuring device 2 includes a tape, a ruler, an optical distance-measuring device, etc.

The imaging device 3, such as a camera, shoots the object 1 and acquires an object image that is a plane projection image of the three-dimensional object. The data format of the object image generated by the imaging device 3 is not limited. For example, an analog signal format such as a red-green-blue (RGB) signal, and a digital signal format such as MPEG-1 (moving picture experts group-1), MPEG-2, MPEG-4, H-263, H-264, etc., may be used.

The server device 4 receives the object image acquired by the imaging device 3 from a user, and the display size and length information thereof which are to be transmitted to the image-data output device 20a.

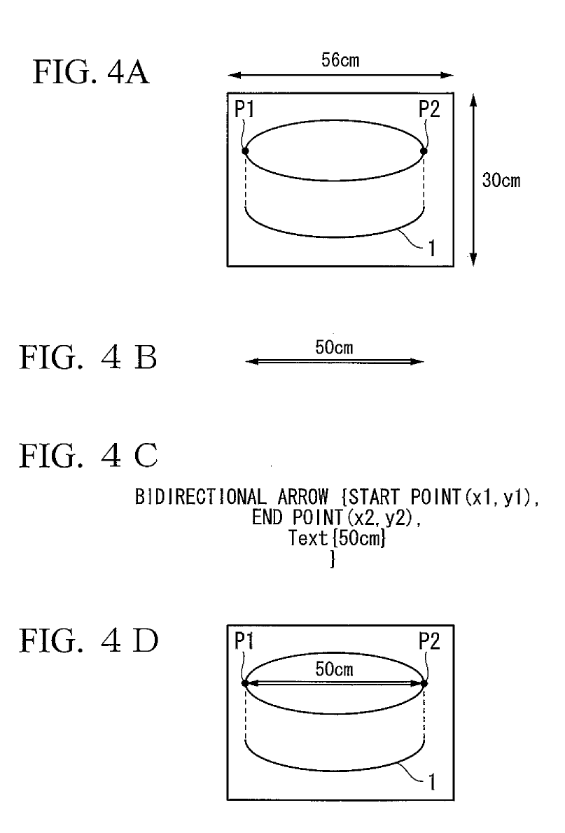

The display size and the length information are explained. The user inputs the display size of the object image to the server device 4. This display size is the size for the display device 5a that is a two-dimensional display to display the object image, and information concerning a centimeter, an inch, or the like. In other words, the display size is the height and the width of the minimum rectangular frame including the two-dimensional object image, such as 56 cm×30 cm. Using the measuring device 2, the user measures the length of a portion that is to be actual size when the object image is displayed according to the input size. The length information includes information indicative of positions of both ends of the measured portion (position coordinates within the object image), and information indicative of the measured length. Preferably, the positions of both ends are set to positions by which the user viewing the object image can easily realize the actual size length. In a case of a cheesecake shown in FIG. 4 explained hereinafter, the positions of both ends of a laterally longest portion on the upper plane are set preferably. In a case of an “open umbrella” shown in FIG. 20 explained hereinafter, the positions of both ends of a laterally longest portion of the umbrella cover are set preferably. Hereinafter, the display size and the length information are collectively called “display related information”.

The display device 5a includes a liquid crystal display, a plasma display, an organic electroluminescence display, and the like, and the display surface of the display device 5a includes a dot matrix (a matrix including plural display dots arranged in a matrix on a plane). The display device 5a may be included in the image-data output device 20a, or separated therefrom. Hereinafter, the display device 5a is separated from the image-data output device 20a. Specific processing executed by the display device 5a is explained after the image-data output device 20a is explained.

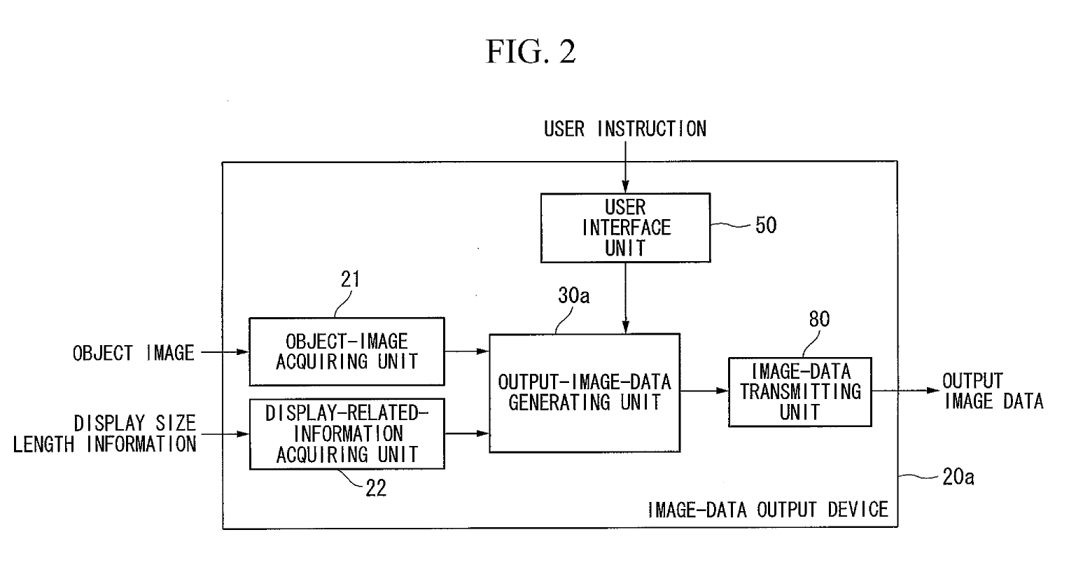

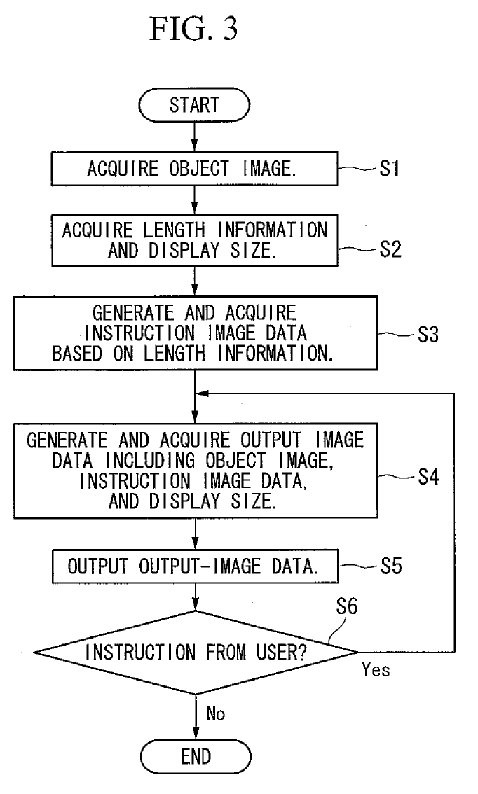

The image-data output device 20a is explained below. FIG. 2 is a schematic block diagram showing a detailed configuration of the image-data output device 20a. As shown in FIG. 2, the image-data output device 20a includes an object-image acquiring unit 21, a display-related-information acquiring unit 22, an output-image-data generating unit 30a, a user interface unit 50, and an image-data transmitting unit 80. FIG. 3 is a schematic showing a processing flow of the image-data output device 20a. With reference to FIGS. 2 and 3, the image-data output device 20a is explained below.

The object-image acquiring unit 21 is a communication device, and receives the object image from the server device 4 (step S1). The display-related-information acquiring unit 22 is also a communication device, and receives the length information and the display size from the server device 4 (a display-size acquiring unit, step S2).

The output-image-data generating unit 30a is an information processing device, and acquires, from the length information, the position coordinates of both ends, and the actual-size length between both ends. Additionally, the output-image-data generating unit 30a shows each of the acquired position coordinates, generates and acquires instruction image data including data (character string) indicative of the acquired actual-size length (an instruction image-data acquiring unit, step S3). Furthermore, the output-image-data generating unit 30a generates and acquires output image data including the object image, the instruction image data, and the display size (step S4).

The image-data transmitting unit 80 is a communication device that executes wired, wireless, or infrared communication, and outputs the output image data generated by the output-image-data generating unit 30a to the display device 5a (an output unit, step S5).

Specific examples of the output image data are explained.

FIG. 4A shows an example of the object image. As shown in FIG. 4A, the object 1 is a cylindrical cheesecake. The object image is configured such that the length between positions P1 and P2 becomes actual size when the display size is 56 cm×30 cm.

FIG. 4B shows a display example (instruction image) of the instruction image data. The instruction image shown in FIG. 4B includes a bidirectional arrow between the positions P1 and P2, and a character string (“50 cm”) indicative of the actual size length between the positions P1 and P2.

FIG. 4C shows an example of the instruction image data corresponding to FIG. 4B, where position coordinates of the positions P1 and P2 within the object image are (x1, y1) and (x2, y2), respectively. As shown in FIG. 4C, the instruction image data includes instruction data “bidirectional arrow” indicating that the bidirectional arrow should be displayed, data “start point (x1, y1)” indicating that a start point of the bidirectional arrow is the position P1, data “end point (x2, y2)” indicating that an end point of the bidirectional arrow is the position P2, and data “Text {50 cm}” indicating that a character string to be displayed additionally is “50 cm”.

FIG. 4D shows a display example of the output image data displayed by the display device 5a. As shown in FIG. 4D, the display device 5a displays the object image and the instruction image that are superimposed. Due to this display, the user can identify the actual size portion in the image of the object 1.

FIG. 5 shows an example of the output image data. An example of the output image data generated using scalable vector graphics (SVG) is shown in FIG. 5, and the format of the instruction image data is different from that of FIG. 4. This output image data includes an <svg> element, an <image> element, a <path> element, and a <text> element.

The <svg> element includes a width attribute, a height attribute, and a viewbox attribute, data between <svg> and </svg> is recognized by the display device 5a as the output image data. The output-image-data generating unit 30a sets the display size (56 cm and 30 cm in the case of FIG. 5) to the width attribute and the height attribute of the <svg> element. The dot size (560 dots×300 dots in the case of FIG. 5) of a dot space to be set to a display area having the display size is set to the viewbox attribute. In the present embodiment, the dot size set to the viewbox attribute is the dot size of the object image input by the object-image acquiring unit 21.

Data related to the image displayed by the display device 5a is set to the <image> element the <path> element, and the <text> element. Specifically, the <image> element includes an xlink:href attribute, an x-attribute, a y-attribute, a width attribute, and a height attribute. The xlink:href attribute is for setting a storage position of an image file, and the image file to be set here constitutes a part of the output image data. The output-image-data generating unit 30a sets the storage position of the image file to the xlink:href attribute (“./obj.jpg” in the case of FIG. 5). The coordinates on the dot space of the upper-left corner of the image indicated by the image file are set to the x-attribute and the y-attribute (both 30 dots in the case of FIG. 5). The dot size of the image is set to the width and the height attributes (500 dotsx240 dots in the case of FIG. 5).

The <path> element includes a d-attribute. Each of characters M, L, and Z, and plural coordinates can be designated to the d-attribute, and a segment connecting the designated coordinates is displayed by the display device 5a. M, L, and Z indicate movement of the focused coordinates, drawing start and end of the segment between the adjacent coordinates, respectively. The output-image-data generating unit 30a sets, to the <path> element, coordinate groups for the display device 5a to draw the bidirectional arrow shown in FIG. 4B.

The <text> element includes an x-attribute and a y-attribute, and a character string between <text> and </text> is displayed, by the display device 5a, at the position specified by the x-attribute and the y-attribute on the dot space. The output-image-data generating unit 30a sets a dot coordinate of the upper left of the character string “50 cm” shown in FIG. 4B (260 dotsx 120 dots in the case of FIG. 5) to the x-attribute and the y-attribute, and also sets the character string “50 cm” between <text> and </text>.

The display device 5a retrieves the object image, the instruction image data, and the display size from the output image data explained above. The object image in the case of FIG. 5 is the image of 560×300 dots including the image specified by the image file obj.jpg. The display device 5a displays the object image according to the display size, and additionally executes display processing based on the instruction image data.

With reference to the case of FIG. 5, the processing executed by the display device 5a is explained in detail. The display device 5a draws, in the dot space of the dot size specified by the viewbox attribute, the images specified by the <image> element, the <path> element, and the <text> element. Assuming that there is a display area of the display size set to the width and the height attributes of the <svg> element, the display device 5a acquires the dot size of the display area based on a dot pitch of the dot matrix (a dot pitch on the display surface). In other words, the display device 5a acquires, as the dot size of the display area, a value obtained by dividing the display size by the dot pitch. The display device 5a enlarges or reduces the drawn image (the image of the dot size specified by the viewbox attribute) to the dot size of the display area using linear interpolation, for example. Additionally, the display device 5a displays the enlarged or reduced image in the prepared display area.

FIG. 6 is a schematic view for simply explaining the display by the display device 5a. In the case of FIG. 6, the display size is 56 cm×30 cm, and the output image data including the display size is input to the display device 5a. The display device 5a acquires the image by executing drawing processing based on the input output-image-data, enlarges or reduces the acquired image to the dot size of the display area having the display size of 56 cmx 30 cm, and displays the image. The image displayed in this manner fits into the 56 cm×30 cm display area.

With reference to FIGS. 2 and 3, further explanation of the image output device 20a is given.

The user interface 50 is an input device that arbitrarily includes a keyboard, a remote control, a mouse, a microphone, etc., each of which has a function of receiving a user input with respect to the image displayed by the display device 5a. Here, the user interface 50 receives inputs of the display size for displaying the object image in actual size, an instruction for execution or cancellation of displaying the object image in actual size, an instruction for enlarging or reducing the entire display or a part thereof, an instruction for displaying or deleting the instruction image data, an instruction for rotation or transformation of the output image data, etc. When the user interface unit 50 receives a user input (step S6: YES), the output-image-data generating unit 30a regenerates output image data according to the received user input, and outputs the regenerated output image data to the display device 5a. In this case, the length between the position coordinates specified by the instruction image data does not always become actual size. In this case, the output-image-data generating unit 30a may not include the instruction image data in the output image data to be generated.

As explained above, according to the first embodiment, when a three-dimensional object is displayed in actual size on a two-dimensional display, an actual-size portion can be clearly specified by the instruction image.

Furthermore, upon viewing the image displayed by the display device 5a, a user can realize the length of the portion specified by the character string.

Moreover, the image-data output device 20a outputs the display size to the display device 5a, thereby implementing the actual size display of the object image.

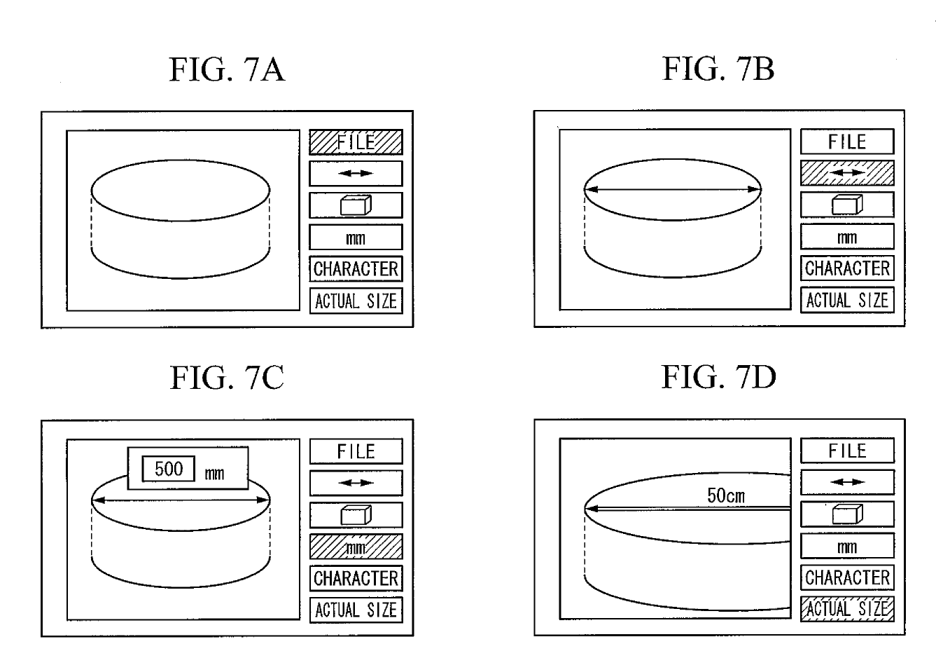

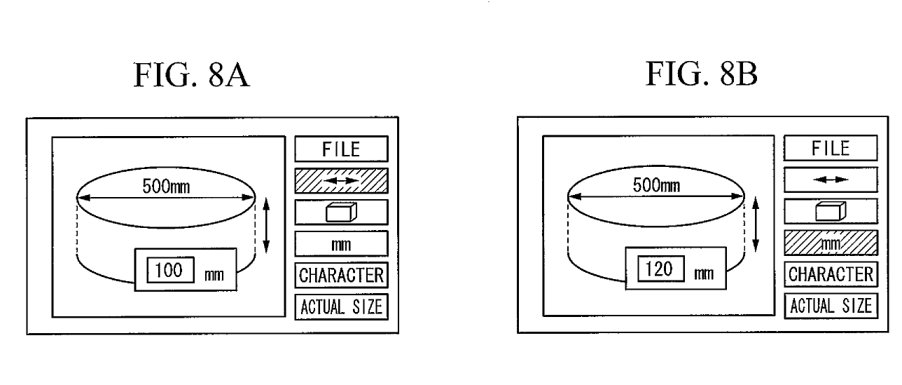

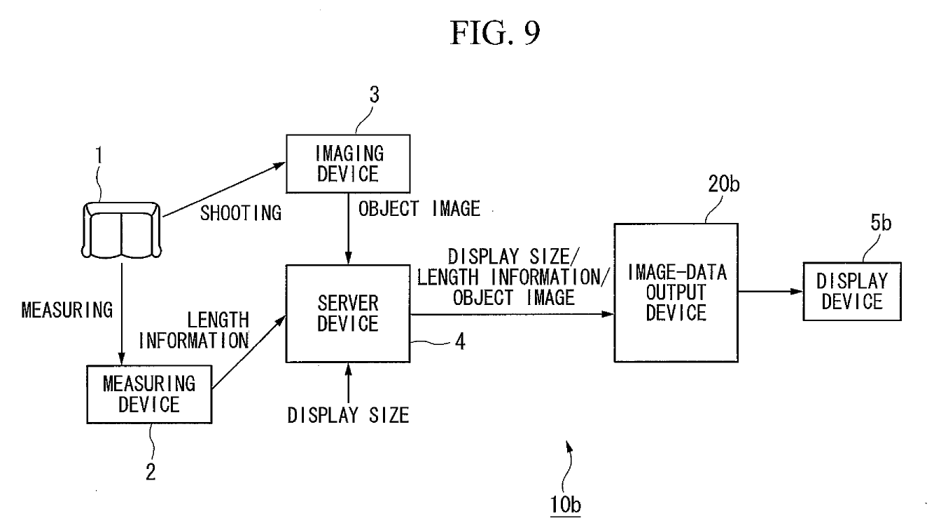

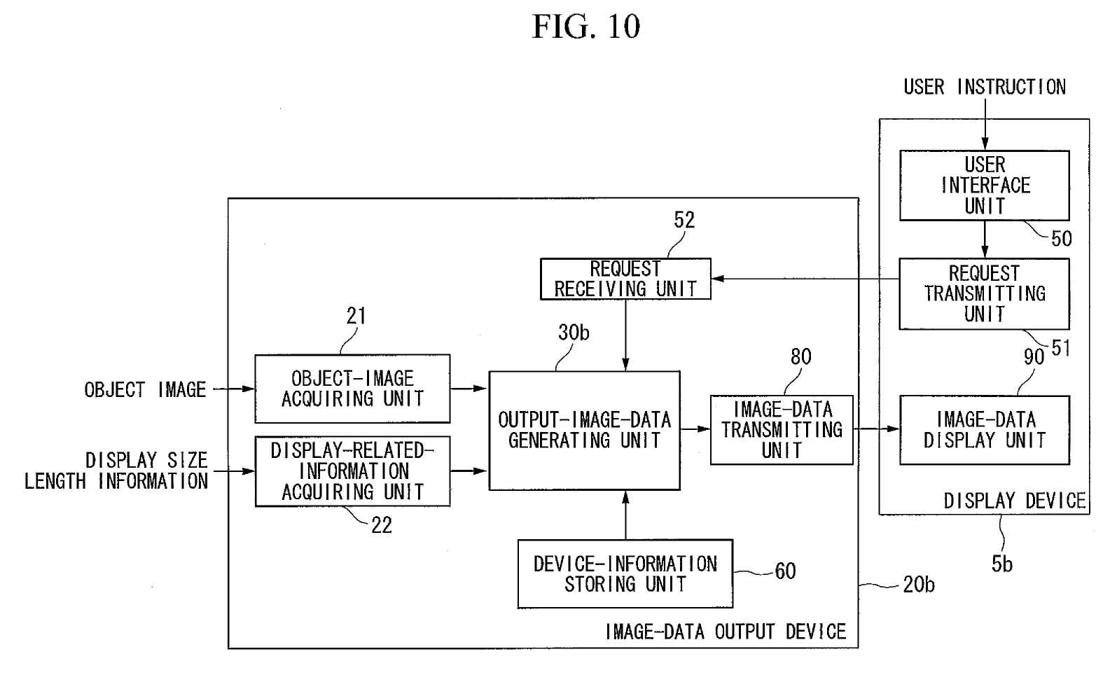

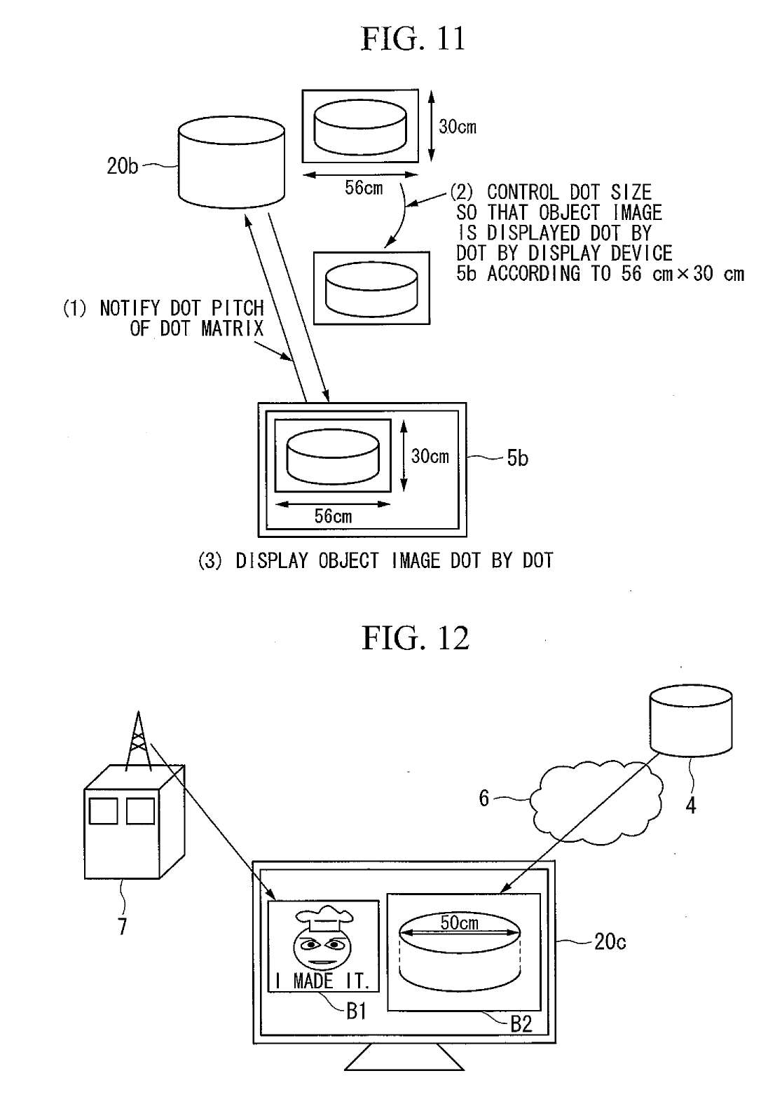

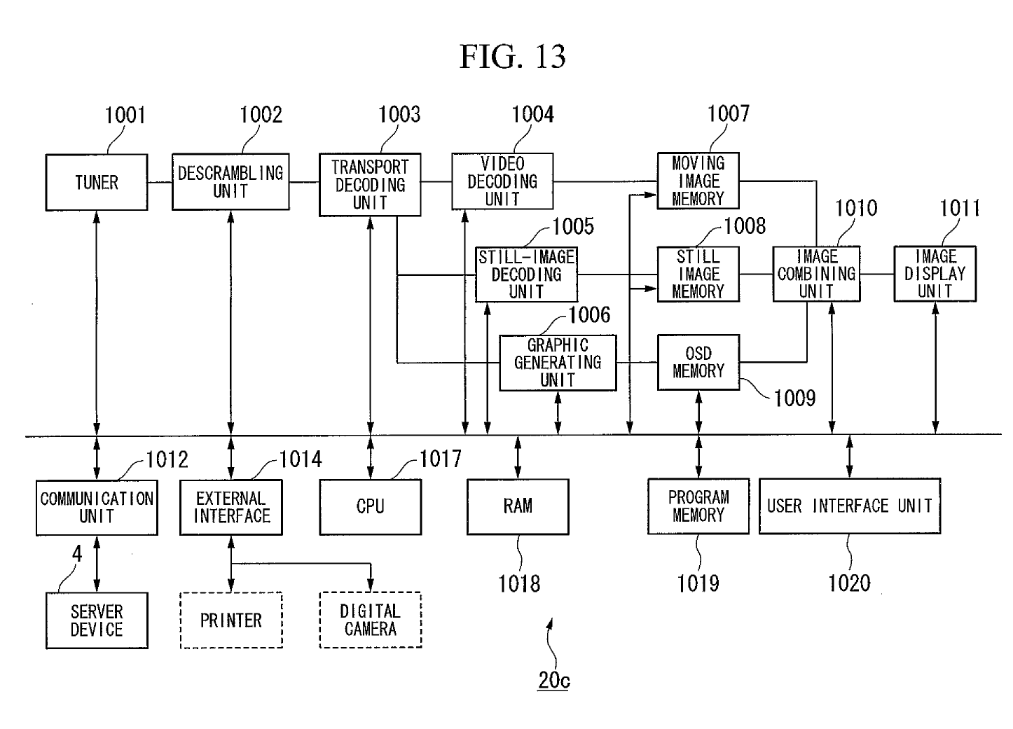

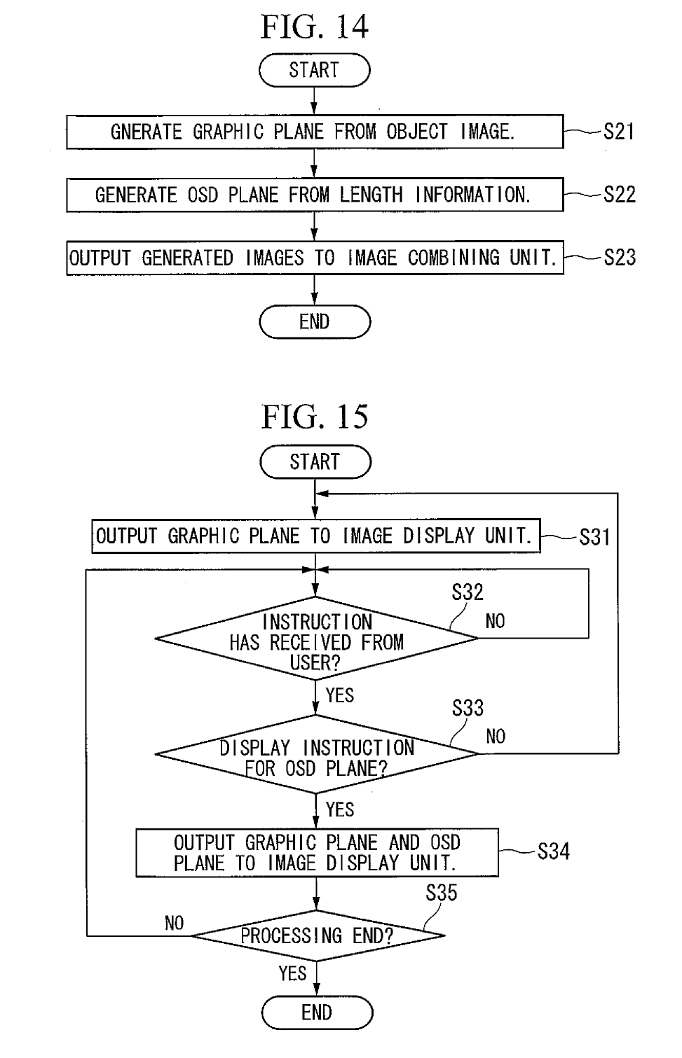

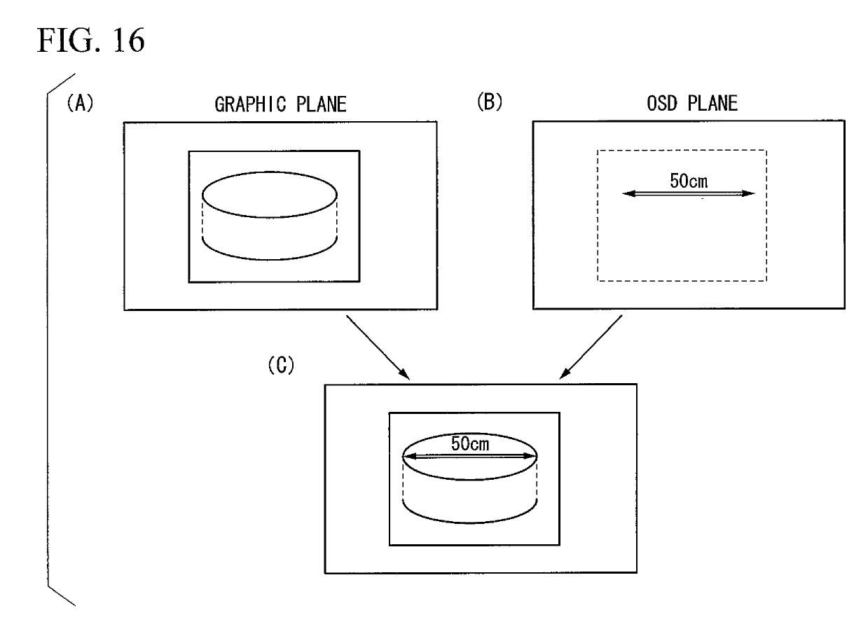

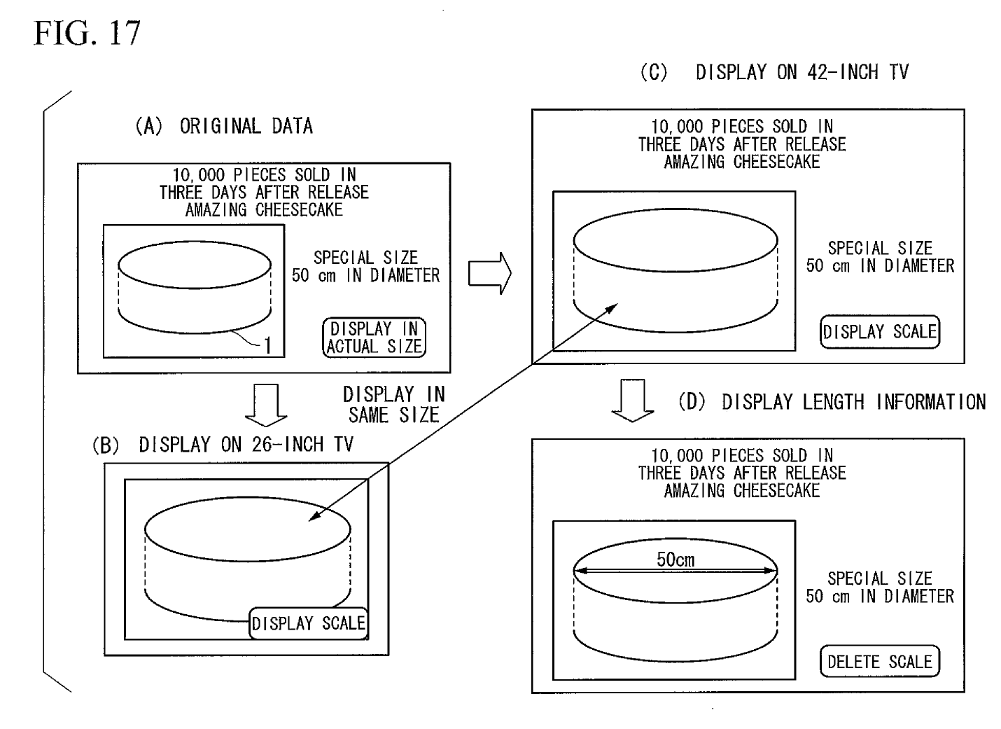

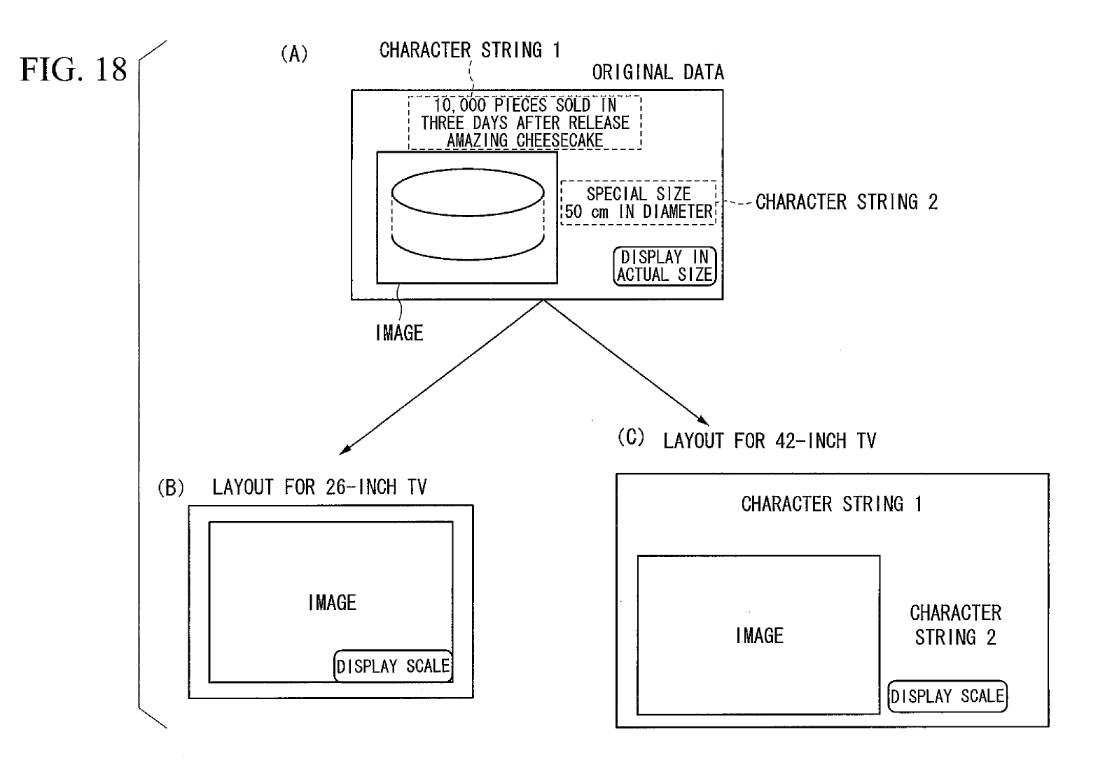

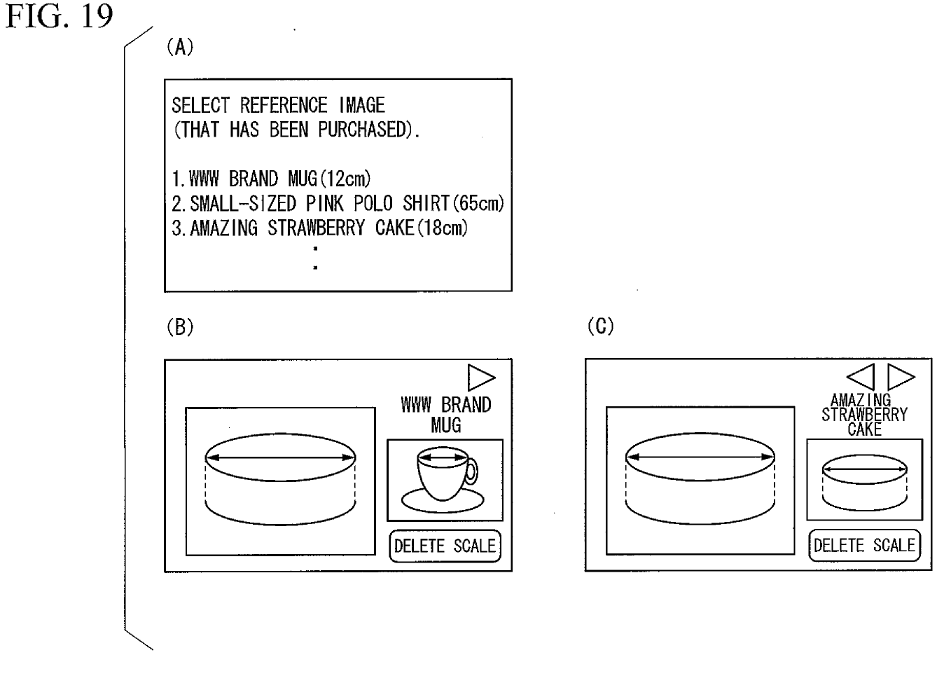

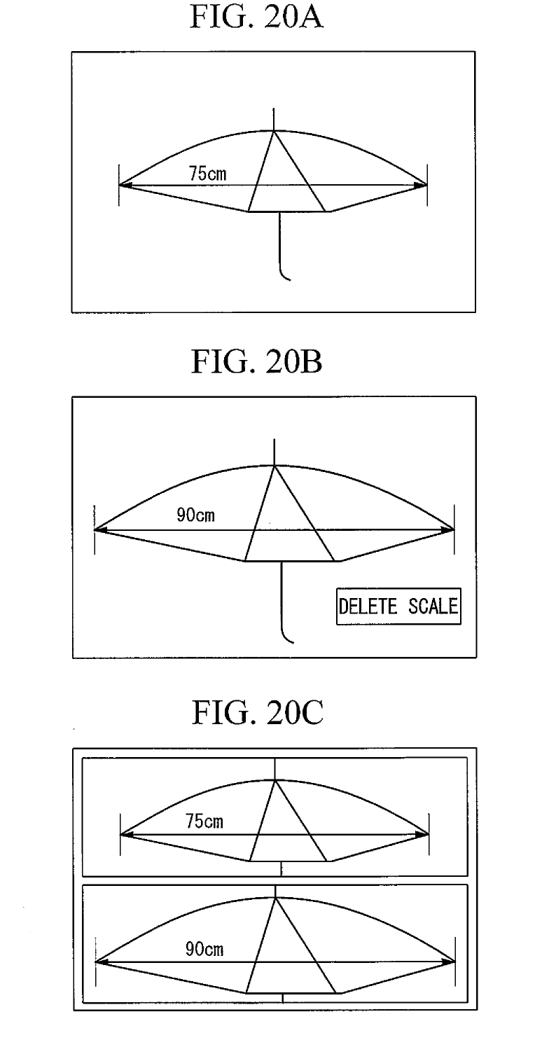

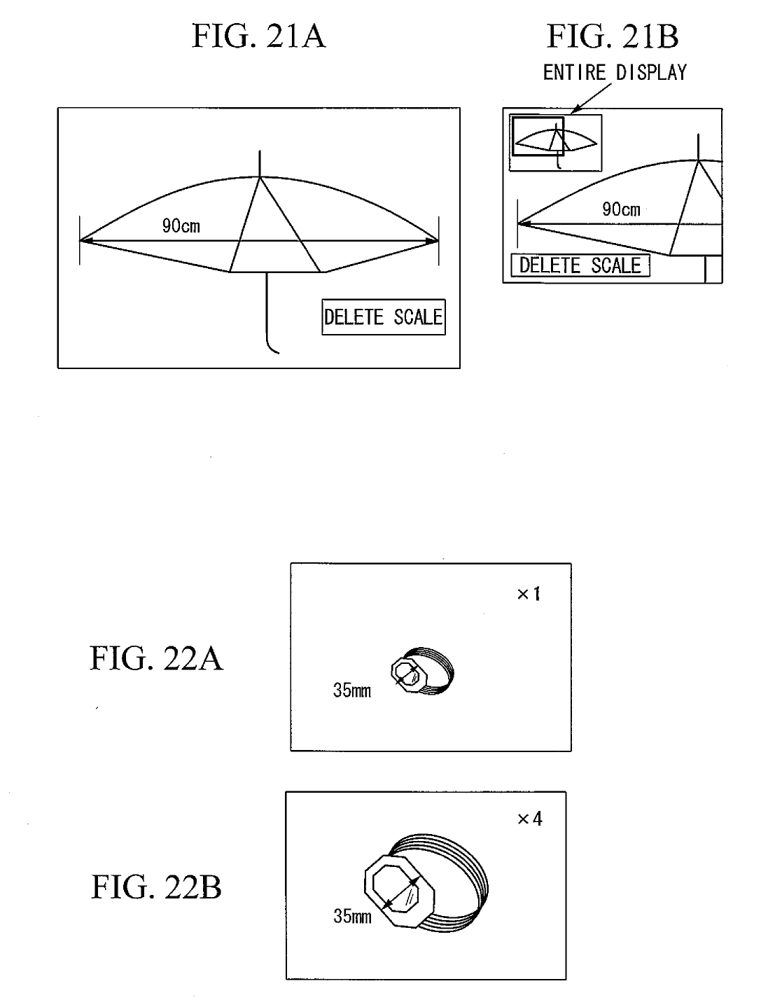

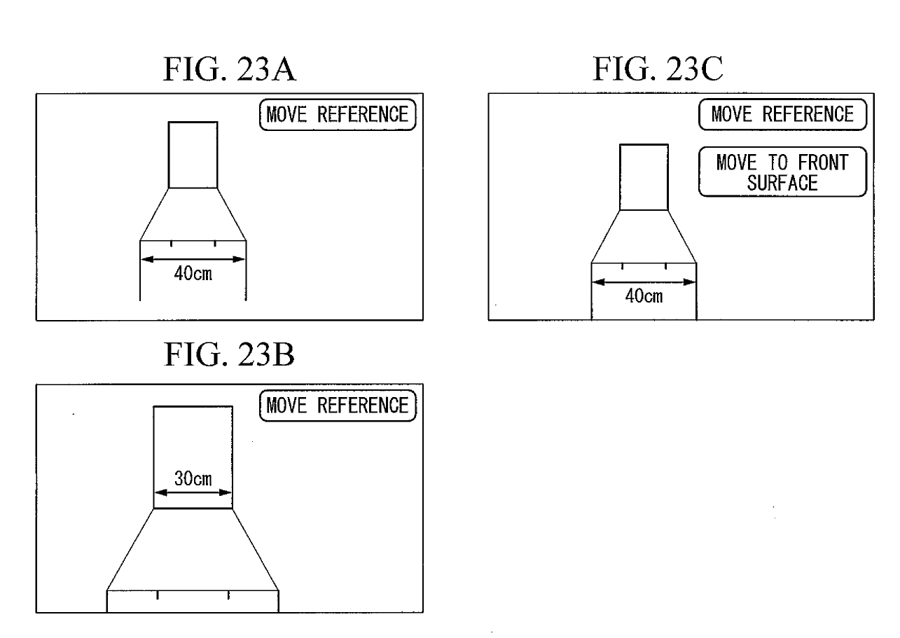

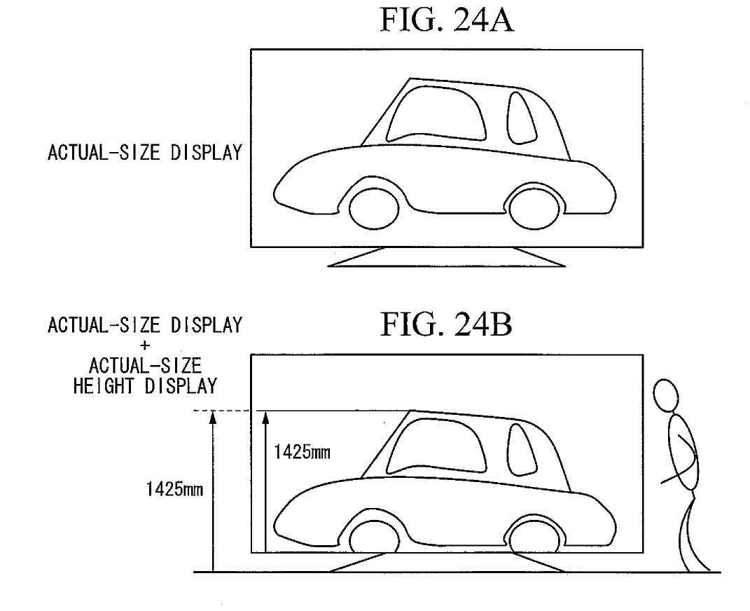

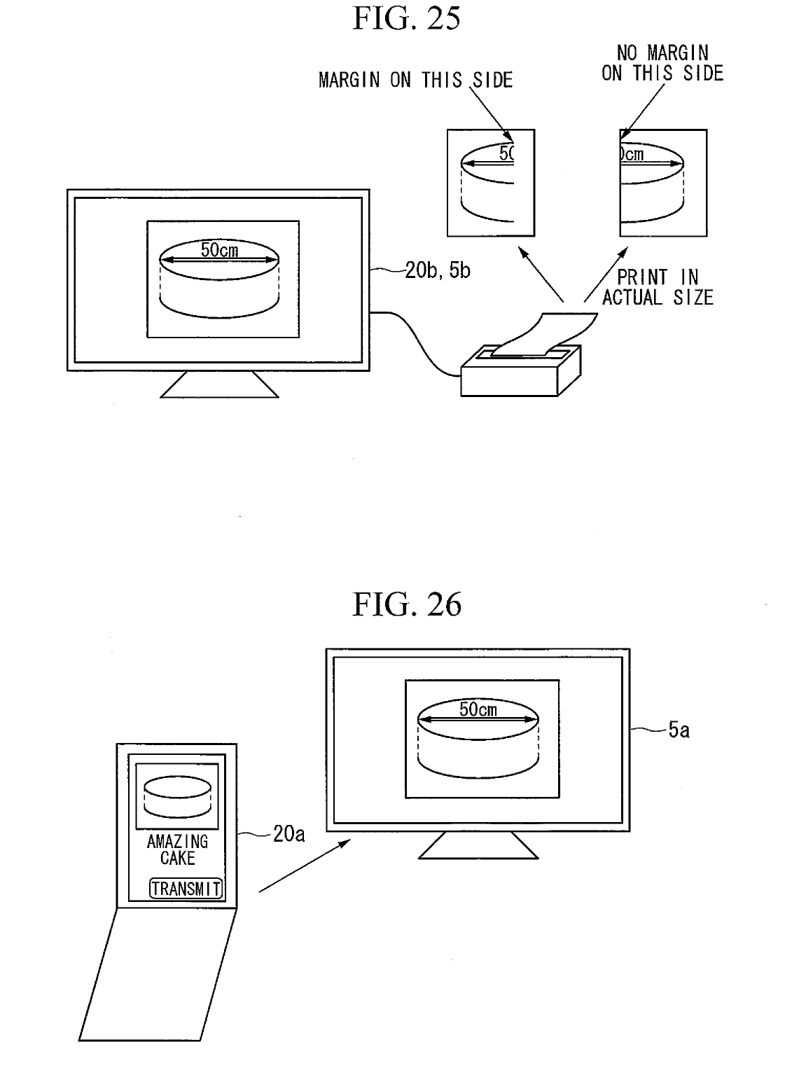

An authoring tool for inputting the length information is explained below. The authoring tool is software executed by the server device 4. FIGS. 7 and 8 show examples of the display screen of the server device 4 by implementation of the authoring tool. FIG. 7A shows a case in which the obj ect image is displayed on the display. The numbers of horizontal and vertical dots are given. FIG. 7B shows a state in which an arrow is inserted onto the object image at the portion where the length is to be displayed. FIG. 7C shows a case in which the user inputs the actual-size length of the inserted arrow shown in FIG. 7B (500 mm in this case). The server device 4 acquires the length information from the input arrow and the actual-size length. The server device 4 calculates a dot pitch by dividing the input actual-size length by the dot length of the arrow.

FIG. 7D shows an example preview of the actual-size display of the object image. The server device 4 executes the preview by generating the output image data in a similar manner to the image-data output device 20a.

As shown in FIG. 8A, the user inputs a vertical arrow on the display. The server device 4 calculates the actual-size length of the arrow based on the calculated dot pitch and the dot length of the input arrow, and automatically inputs the length of the arrow (100 mm in this case). This processing is applicable only when two lengths can be simultaneously displayed in actual size. In other words, the automatic input processing is executable only when the calculated dot pitches with respect to the two arrows are the same.

FIG. 8B shows a case in which the user replaces the number of the automatically-input length with 120 mm. In this case, the server device 4 calculates the dot length of the arrow based on the replaced number, and automatically changes the length of the arrow.

With the use of the authoring tool explained above, the user can easily input the length information.

### Second Embodiment

In the first embodiment, the case in which the display device 5a enlarges or reduces the object image according to the display size, and implements the display in actual size is explained. On the other hand, in the second embodiment, a case in which a display device 5b is used that executes the display in a dot-by-dot mode (display mode in which each dot of the object image corresponds to each dot of the dot matrix) is explained. In such a case, an image-data output device 20b having a function of controlling the dot size of the object image based on the dot pitch of the dot matrix to make the object image be the display size as a result of the dot-by-dot display is necessary for the display in actual size, which is explained in detail below.

FIG. 9 shows a system configuration of an image-data display system 10b according to the second embodiment. As shown in FIG. 9, the image-data display system 10b is obtained by replacing the image-data output device 20a and the display device 5a of the image-data display system 10a with the image-data output device 20b and the display device 5b, respectively.

FIG. 10 shows a detailed configuration of the image-data output device 20b and the display device 5b. As shown in FIG. 10, like reference numbers represent like blocks shown in FIG. 2. The image-data output device 20b includes the object-image acquiring unit 21, the display-related-information acquiring unit 22, an output-image-data generating unit 30b, a request receiving unit 52, a device-information storing unit 60, and an image-data transmitting unit 80. On the other hand, the display device 5b includes the user interface unit 50, a request transmitting unit 51, and an image-data display unit 90.

A display surface of the image-data display unit 90 includes a dot matrix, and an input image is displayed dot by dot thereon. The image-data display unit 90 is explained in detail hereinafter.

The device-information storing unit 60 is a storage device that stores the dot pitch of the dot matrix included in the image-data displaying unit 90. Additionally, the device-information storing unit 60 may store information concerning the display device 5b (the screen size, a resolution, a specification of a view angle, a communication protocol in use, etc.).

The output-image-data generating unit 30b controls the dot size of the object image based on the display size and the dot pitch of the dot matrix (a dot-size control unit). For example, when the display size is L1 cm×L2 cm and the dot pitch is M cm, the output-image-data generating unit 30b sets the dot size of the object image to be (L1/M) dots×(L2/M) dots. More specifically, this control is enlargement-and-reduction processing of the dot size of the object image based on linear interpolation, for example. As a result of the control, the output-image-data generating unit 30b acquires the object image, the dot size of which is reduced.

The output-image-data generating unit 30b generates the output image data in a similar manner to the output-image-data generating unit 30a using the object image enlarged or reduced by the control. Although the output-image-data generating unit 30b acquires the instruction image data in a similar manner to the output-image-data generating unit 30a at this time (an instruction image-data acquiring unit), the output-image-data generating unit 30b also controls the content of the instruction image data according to the dot size of the object image. In other words, for example, when the instruction image as a result of the display of the instruction image data is the bidirectional arrow as shown in FIG. 4B, the content of the instruction image data is controlled such that both ends of the bidirectional arrow are positioned at the positions of both ends within the object image when being superimposed onto the object image and displayed. More specifically, the position coordinates of both ends included in the instruction image data are changed according to the position coordinates of both ends within the enlarged-or-reduced object image. The image-data transmitting unit 80 transmits, to the display unit 5b, the output image data generated by the output-image-data generating unit 30b (an output unit).

The image-data display unit 90 displays the object image included in the output image data input from the image-data output device 20b such that each dot of the object image corresponds to each dot of the dot matrix. When the dot size of the object image is (L1/M) dots×(L2/M) dots and the dot pitch of the dot matrix is M cm, the display size to be displayed as a result is (L1/W×M cm×(L2/M)×M cm=L1 cm×L2 cm, i.e., the display size. The image-data display unit 90 displays the instruction image data included in the output image data in a similar manner to the display device 5a.

FIG. 11 is a schematic view for simply explaining the dot size control by the output-image-data generating unit 30b, and the display by the image-data display unit 90. In the case of FIG. 11, the display size is 56 cm×30 cm. The display device 5b notifies the image-data output device 20b of the dot pitch of the dot matrix included in the image-data display unit 90, and the device-information storing unit 60 of the image-data output device 20b stores the dot pitch. The output-image-data generating unit 30b reads the dot pitch from the device-information storing unit 60, and generates the output image data by controlling the dot size of the object image so that the display size becomes 56 cm×30 cm upon being displayed dot by dot by the image-data display unit 90. When the image-data display unit 90 displays the output image data generated in this manner, the object image is displayed in the size of 56 cm×30 cm.

In the present embodiment, the user interface unit 50 is included in the display unit 5b. Although a function of the user interface unit 50 is similar to that explained in the first embodiment, the user input received by the user interface unit 50 is transferred to the output-image-data generating unit 30b through the request transmitting unit 51 and the request receiving unit 52. According to the transferred user input, the output-image-data generating unit 30b regenerates output image data in a similar manner to the output-image-data generating unit 30a.

As explained above, according to the second embodiment and similar to the first embodiment, when a three-dimensional object is displayed in actual size on a two-dimensional display, an actual size portion can be clearly specified by the instruction image, and the dot size of the object image can be determined so that the object image is displayed dot by dot according to the display size by the display device 5b, thereby implementing the display in actual size even when the display device 5b that executes the dot-by-dot display is used.

### Third Embodiment

In the third embodiment, an image-data output device 20c having a function of receiving a TV broadcast and simultaneously displaying a broadcast display and the object image on one screen is explained. The image-data output device 20c includes a display device, which is different from the image-data output devices 20a and 20b.

FIG. 12 is a schematic view for explaining the outline of the image-data output device 20c according to the third embodiment. As shown in FIG. 12, the image-data output device 20c receives a TV broadcast from a TV station 7, and simultaneously displays, on the built-in display device, a broadcast display B1 and an object image B2 received from the server device 4 through network 6.

FIG. 13 shows the hardware configuration of the image-data output device 20c. As shown in FIG. 13, the image-data output device 20c includes a tuner 1001, a descrambling (decoding) unit 1002, a transport decoding unit 1003, a video decoding unit 1004, a still-image decoding unit 1005, a graphic generating unit 1006, a moving image memory 1007, a still image memory 1008, an on-screen-display (OSD) memory 1009, an image combining unit 1010, an image display unit 1011, a communication unit 1012, an external interface 1014, a central processing unit (CPU) 1017, a RAM (random access memory) 1018, a program memory 1019, and a user interface unit 1020. Each element is implemented as an LSI for a TV.

The tuner 1001 acquires broadcast data by receiving external broadcast waves. In lieu of the tuner 1001, a communication unit may be provided that receives broadcast data by multicast or unicast. The descrambling unit 1002 descrambles the data acquired by the tuner 1001, if scrambled. When the data is received as packet communication, the data has to be descrambled per packet, in some cases. The transport decoding unit 1003 extracts, from the data descrambled by the descrambling unit 1002, video data, still image data such as JPEG, additional data such as an electronic program listing and data broadcast, audio data, etc.

The video decoding unit 1004 decodes the video data extracted by the transport decoding unit 1003 (that has been generated in the format of MPEG2 or H.264), and draws a video image. The still-image decoding unit 1005 decodes still image data among the data extracted by the transport decoding unit 1003, and draws a still image.

The graphic generating unit 1006 draws a display image of the additional data among the data extracted by the transport decoding unit 1003. In general, the additional data is described in broadcast markup language (BML) and interpreted by the CPU 1017 after being extracted by the transport decoding unit 1003. An interpretation result by the CPU 1017 is input to the graphic generating unit 1006.

The moving-image memory 1007 stores the video image drawn by the video decoding unit 1004. The still-image memory 1008 stores the still image drawn by the still-image decoding unit 1005. The OSD memory 1009 stores the display image drawn by the graphic generating unit 1006.

The image combining unit 1010 overlaps the areas drawn by the moving image memory 1007, the still image memory 1008, and the OSD memory 1009, and synthesizes the final display screen. The display combining unit 1010 executes the combining processing periodically at given interval of redrawing time. The image combining unit 1010 also executes processing of enlargement, reduction and alpha blending.

The image display 1011 is a liquid crystal driver and a liquid crystal display, and displays dot by dot the display screen synthesized by the image combining unit 1010.

The communication unit 1012 communicates with the server device 4, etc., using an internet protocol. Specifically, the communication unit 1012 is an interface for TCP/IP, wireless LAN, power line communication, etc. The communication unit 1012 receives, from the server device 4, an object image, length information, and the display size that are similar to those in the first embodiment (a display-size acquiring unit).

The external interface 1014 communicates with an external device such as a printer, a digital camera, and a cellular phone. Specifically, the external interface 1014 is a USB interface, an infrared interface, a Bluetooth interface, a wireless LAN interface, etc.

The CPU 1017 reads the program stored in the program memory 1019, and operates according to the read program. Based on this operation, the CPU 1017 controls the entire image-data output device 20c. Additionally the CPU 1017 executes the processing of interpreting the additional data extracted by the transport decoding unit 1003 and outputting the interpretation result to the graphic generating unit 1006, and the processing of generating the still image and the display image based on the object image, the length information, and the display size that are received from the server device 4 through the communication unit 1012, and outputting the generated images to the OSD memory 1009.

The RAM 1018 is a random access memory that stores various data. The program memory 1019 is a program memory for retaining a program or fixed data, and includes a flash memory, etc.

FIGS. 14 and 15 show processing flows of the processing for displaying the object image B2 (shown in FIG. 12) among the processing executed by the image-data output device 20c. FIG. 16 is an explanatory view showing the processing. The processing is explained below with reference to FIGS. 14 to 16.

The CPU 1017 enlarges or reduces the dot size of the object image received by the communication unit 1012 based on the dot pitch of the dot matrix of the image display unit 1011 so that the dot size becomes the display size when the object image is displayed by the image display unit 1011 (a dot-size control unit). Specifically, this processing is similar to that in the second embodiment. The CPU 1017 stores the enlarged or reduced object image in the still image memory 1008 (a first memory) as a still image (an output unit, step S21 shown in FIG. 14). The image stored in the still image memory 1008 is called a graphic plane. FIG. 16A shows an example of the graphic plane.

The CPU 1017 acquires, from the length information received by the communication unit 1012, the position coordinates of both ends included in the length information, and changes the acquired position coordinates according to the position coordinates of both ends within the object image that has been enlarged or reduced. The CPU 1017 specifies the changed position coordinates, and generates and acquires instruction image data including data (character string) indicative of the actual size length included in the length information (an instruction image-data acquiring unit). The CPU 1017 generates an instruction image by executing the drawing processing based on the instruction image data, and stores the generated instruction image in the OSD memory 1009 (second memory) as the display image (an output unit, step S22 shown in FIG. 14). The image stored in the OSD memory 1009 is called an OSD plane. FIG. 16B shows an example of the OSD plane. In the OSD plane shown in FIG. 16B, other parts than the instruction image are transparent.

The still image memory 1008 and the OSD memory 1009 outputs the stored graphic plane and the OSD plane to the image combining unit 1010, respectively (step S23 shown in FIG. 14).

The image combining unit 1010 outputs, to the image display unit 1011, only the graphic plane stored in the still image memory 1008 (step S31 shown in FIG. 15). After a user instruction is anticipated through the user interface unit 1020 (step S32 shown in FIG. 15), and when the user instruction is input, whether or not the instruction is a display instruction for the OSD plane is determined (step S33 shown in FIG. 15). When the instruction is not a display instruction for the OSD plane, the processing of the image combining unit 1010 returns to step S31. On the other hand, when the instruction is the display instruction for the OSD plane, the image combining unit 1010 superimposes the OSD plane onto the graphic plane, and outputs the superimposed plane to the image display unit 1011 (an image combining unit, step S34 shown in FIG. 15). The image displayed as the result becomes the object image on which the instruction image is displayed as shown in FIG. 16C. After the output, the image combining unit 1010 waits for an instruction for an end of the display from a user for a given period (step S35 shown in FIG. 15), and finishes the display by the image display unit 1011 when the instruction for the end of the display is input. When the instruction for the end of the display is not input, the processing of the image combining unit 1010 returns to step S32.

As explained above, according to the third embodiment and similar to the first and the second embodiments, when a three-dimensional object is displayed in actual size on a two-dimensional display, an actual-size portion can be clearly specified by the instruction image, and the broadcast display and the object image can be simultaneously displayed on one screen.

Preferably, the content of the object image to be displayed is information concerning a product introduced by the broadcast. In this case, a user can view the broadcast and acquire detailed information on the product using online services at the same time. Furthermore, the product is displayed in actual size, thereby increasing the probability that the user will purchase the product at that time.

Specifically, a TV that has received program information (that may be only channel information) included in the digital broadcast transmits the program information to the specific server device 4. The server device 4 analyzes the received program information, and distributes, to the TV, content (a combination of the object image, the length information, and the display size) for the actual-size display of the product introduced on the program. As a result, the image-data output device 20c can display, in actual size, the information concerning the product introduced by the broadcast and the instruction image data at the same time.

### Fourth Embodiment

A fourth embodiment is an application of the first embodiment. In the present embodiment, the object image is included in an image generated by HTML (hyper text markup language) (HTML image), the image-data output device 20a displays the object image in actual size, and clearly specifies an actual-size portion. Additionally, the image-data output device 20a controls the content of the HTML image such that the entire HTML image fits in the screen size irrespective of the screen size of the display device 5a.

FIG. 17 shows a specific example of the fourth embodiment. FIG. 18 is a schematic view for explaining processing executed by the image-data output device 20a. With reference to FIGS. 17 and 18, the processing executed by the image-data output device 20a is explained below.

FIG. 17A shows an example of the HTML image. Constituent elements of the HTML image shown in FIG. 17A are shown in FIG. 18A. As shown in FIG. 18A, the HTML image shown in FIG. 17A includes a character string 1 “10,000 PIECES SOLD IN THREE DAYS AFTER RELEASE, AMAZING CHEESECAKE”, a character string 2 “SPECIAL SIZE 50 CM IN DIAMETER”, a button image to which a character string “DISPLAY IN ACTUAL SIZE” is added (hereinafter, actual size-display instruction button), and the object image of the object 1 that is a cylindrical cheesecake (which is acquired by the object-image acquiring unit 21). The object 1 has a diameter of 50 cm. The image-data output device 20a generates the HTML image shown in FIG. 17A, and outputs the generated HTML image to the display device 5a. At this time, the object image is not displayed in actual size.

When a user clicks the actual size-display instruction button using the user interface unit 50, the image-data output device 20a commences processing for displaying the object image in actual size. In other words, the image-data output device 20a generates and acquires the instruction image data using the length information acquired by the display-related-information acquiring unit 22, also generates and acquires the output image data including the display size acquired by the display-related-information acquiring unit 22 and the object image. The image-data output device 20a generates the HTML image including the acquired output image data, and outputs the generated HTML image to the display device 5a. At this time, the image-data output device 20a controls the element other than the object image in the HTML image according to the screen size of the display device 5a.

FIG. 17B shows a case in which the display device 5a is a 26-inch TV (the screen size of which is approximately 53 cm×40 cm). FIG. 18B shows an example of a screen layout to be used in this case. In this case, if the object 1 of 50 cm in diameter is displayed in actual size, the object image occupies substantially the entire screen, and there is no room for other images to be inserted. Therefore, the image-data output device 20a does not add, to the HTML image, an element other than the object image.

On the other hand, FIG. 17C shows a case in which the display device 5a is a 42-inch TV (the screen size of which is approximately 85 cm×64 cm). FIG. 18C shows an example of a screen layout to be used in this case. In this case, even if the object 1 of 50 cm in diameter is displayed in actual size, sufficient margins are left. Therefore, the image-data output device 20a adds, to the HTML image, an element other than the object image such as the character strings.

FIGS. 17B and 17C show a button image to which the character string “DISPLAY SCALE” is added (hereinafter, scale-display-instruction button). This button is for switching displaying and hiding of the instruction image, and the image-data output device 20a adds the scale-display-instruction button upon generating the output image data for displaying the object image in actual size.

When the user clicks the scale-display-instruction button using the user interface unit 50, the image-data output device 20a generates and acquires output image data including the instruction image data, generates the HTML image including the acquired output image data, and outputs the generated HTML image to the display device 5a. FIG. 17D shows an example of the HTML image displayed on the display device 5a as a result of the user clicking the scale-display-instruction button in the HTML image shown in FIG. 17C. As shown in FIG. 17D, the instruction image data is displayed in the HTML image shown in FIG. 17D. As shown in FIG. 17D, in the HTML image including the instruction image data, the image-data output device 20a draws a button image to which a character string “DELETE SCALE” (hereinafter, scale-delete-instruction button) is added in lieu of the scale-display-instruction button.

When the user clicks the scale-delete-instruction button using the user interface unit 50, the image-data output device 20a generates and acquires output image data that does not include the instruction image data, generates the HTML image including the acquired output image data, and outputs the generated HTML image to the display device 5a. As a result the HTML image shown on the display device 5a returns to the image shown in FIG. 17C.

### Fifth Embodiment

Even if an image is displayed in actual size, the size of the object cannot be realized intuitively in some cases, since human perception of the size is based on relative information in many cases. Therefore, it is preferable to compare the size of the object with what is familiar to a user. On the other hand, it is preferable that the relative comparison is comparison with what is close to the user scene, such as a cup to a cake, and a trouser to a jacket. Therefore, in the fifth embodiment the image-data output device 20a displays, in the HTML image explained in the fourth embodiment, an image of a reference object as an element other than the object image.

FIG. 19 shows an example of the HTML image displayed by the display device 5a in the fifth embodiment. Upon the display in actual size, the image-data output device 20a draws the HTML image shown in FIG. 19A, and causes the display device 5a to display the drawn HTML image. This HTML image is configured such that the reference object is selectable, and the user selects any reference object using the user interface unit 50. The image-data output device 20a stores the image of each reference object, and length information and the display size for each reference object image, and generates the instruction image data from the length information of the selected reference object image when the user selects the reference object. Additionally, the image-data output device 20a generates the output image data including the generated instruction image data, the reference object image, and the display size, inserts the generated output image data into the HTML image, and outputs the image to the display device 5a.

FIGS. 19B and 19C show display examples of the HTML images on the display device 5a that is generated in the above manner. As shown in FIGS. 19B and 19C, the object image and the reference object image are displayed in parallel in the HTML image.

Preferably, what the user has purchased or checked in the past using online shopping is used for the reference object since the user is likely to be familiar with what the user has already purchased. The user can intuitively realize the size of the object by the display of what the user is familiar with. For example, if a shirt and a skirt are displayed at the same time, the user can realize not only the size, but also coordinates of the shape, the design, or the color.

It is understood that in addition to what the user has purchased, what a general user can imagine such as a cigarette pack, a loaf of bread, and a man 175 cm tall may be selected as the reference object. On the other hand, although the reference object is a cake in the case of FIG. 19, it is preferable to exclude items that are difficult to compare with the cake from objects to be selected, such as a ring or a man whose size greatly differs from the size of the cake.

With the use of the fifth embodiment, two objects in different size can be compared. For example, FIG. 20A shows an umbrella of 75 cm wide, and FIG. 20B shows an umbrella of 90 cm wide. This is a case in which a user wants to buy an umbrella, and the user can compare the two umbrellas displayed in actual size to decide which to buy.

When a relatively large object such as the umbrella is displayed in actual size, there is high possibility that the object cannot fit in the screen. Particularly, when two objects are displayed on one screen, there is higher possibility that the two objects cannot fit in the screen. Although it is considered to reduce and display the two images, the actual-size parts remain and are displayed with the other parts cut off in the case of FIG. 20C. In other words, since the horizontal length of the umbrella cover is important for the comparison of the umbrella size, and the handle part is not relatively important, the object image of each umbrella is displayed with the handle part cut off. Although the object image and the reference object image are displayed in a row in the case of FIG. 19, the umbrellas are displayed one above the other for convenience of the comparison. Preferably, the user can select the display position relation of plural objects to be compared with one another according to need.

### Sixth Embodiment

A sixth embodiment is also an application of the first embodiment. In the present embodiment, a case in which the screen size of the display device 5a is too small compared with the full size of an object to be displayed is explained. FIG. 21A shows a case in which the screen size is large enough to display an umbrella in actual size. On the other hand, FIG. 21B shows a case in which the screen size is too small to display the same umbrella as that shown in FIG. 21A. In the case of FIG. 21B, the image-data output device 20a draws only apart of the object image that can be displayed in actual size, reduces and displays an entire object image on a part of the screen. The image-data output device 20a appropriately moves the display position of the object image according to a user instruction, and clearly specifies the currently displayed position in the entire image using a square. As a result, even if the screen size is too small, the user can realize the actual-size umbrella, and which part thereof the currently displayed umbrella is.

### Seventh Embodiment

A seventh embodiment is also an application of the first embodiment. In the present embodiment is explained a case in which the screen size of the display device 5a is too large compared with the full size of an object to be displayed. FIG. 22A shows a case in which a watch is displayed in actual size. In this case, the screen size is too large compared with the actual size length 35 mm of the clock-displayed part of the watch, and the displayed watch is too small even if the watch is displayed in actual size. In this case, a user is likely to enlarge the object to view the detail thereof. Therefore, the image-data output device 20a enlarges, according to a user instruction, the size of the watch with a given rate (for example, twice or four times the full size) based on the actual-size length specified by the length information (see FIG. 22B). The image-data output device 20a enlarges the instruction image data in a similar manner.

As explained in the fifth embodiment, even when the object image and the reference object image are displayed in parallel, the image-data output device 20a can enlarge and display each image in a similar manner. In this case, the image-data output device 20a enlarges each image based on the actual-size length of each object. As a result, the user can compare the sizes of the object and the reference object that are enlarged.

### Eighth Embodiment

An eighth embodiment is also an application of the first embodiment. In the present embodiment, a case in which one object has two reference surfaces is explained. In a plane projection image of a three-dimensional object, two parts at different distances from a camera cannot simultaneously be displayed in actual size. However, each part can be separately displayed in actual size by switching the display. FIG. 23 shows a plane projection image of a chair shot at the front. In the case of FIG. 23A, the anterior leg is the reference surface, the length between the anterior legs is the actual-size length (40 cm). On the other hand, in the case of FIG. 23B, the back is the reference surface, and the width thereof is the actual-size length (30 cm).

The image-data output device 20a stores two kinds of combinations of the length information and the display size, one of which is the length information indicative of the actual-size length of the anterior legs, and the display size for the displayed length of the anterior legs to be the actual-size length, the other of which is the length information indicative of the actual-size length of the back, and the display size for the displayed length of the back to be the actual-size length. The image-data output device 20a draws, upon generating the output image data, a “MOVE REFERENCE” button in the display, and regenerates output image data when the user clicks this button. At this time, the image-data output device 20a regenerates the output image data switching the two kinds of combinations of the length information and the display size. As a result, FIGS. 23A and 23B are alternately displayed.

Although FIG. 23 is the case in which the two reference surfaces are switched, arbitrary surface can be used as the reference surface with the use of a three-dimensional model of the chair. In other words, since the length of an arbitrary part and the display size for the length to be actual size can be calculated using the three-dimensional model the user designates a part for displaying the instruction image data, and the object is enlarged or rotated according to the user instruction, thereby enabling the actual-size display of the designated part. Additionally, when a camera that can acquire depth information is used for shooting, the length of a part designated by the user can be displayed in actual size in a similar manner to the case of using the three-dimensional model.

Furthermore, in general, a display mode in which the user can realize the object as actual size most intuitively is the display mode such as the case of FIG. 23C in which the front surface of the object is at the position of the screen. In other words, when a TV screen is considered as a window, the display mode is a case in which the object is displayed as being in contact with the backside of the window. Therefore, a “MOVE TO FRONT SURFACE” button may be provided in the image so that the reference is moved to the front surface when the user clicks this button. Furthermore, this display mode may be default.

### Ninth Embodiment

The ninth embodiment is also an application of the first embodiment. In the present embodiment, a case in which the height of an object from the ground that is displayed on the display device 5a is set to the actual size height from the ground is explained.

FIG. 24A shows a case in which a car to be displayed is displayed on the display device 5a having a screen larger than an actual-size car. For the purpose of an advertisement viewed in the distance, the entire car is preferably displayed on the display device 5a as shown in FIG. 24A. However, when a user wants to realize the size of the car for a purchase, the height of the displayed car from the ground is preferably set to the actual-size height from the ground. Therefore, the disposition height of the display device 5a (the height of the lowest part of the screen from the ground) is preliminarily input to the image-data output device 20a. Additionally, the height of the object (height information) is preliminarily included in the length information. The image-data output device 20a acquires the height information from the length information received from the server device 4, and controls the display position of the object image in the screen based on the acquired height information and the preliminarily input disposition height, thereby implementing the display of the object image at the actual-size height.

In this case, it is preferable to display the instruction image data in the height direction so that the user can recognize the actual-size height from the ground.

### Tenth Embodiment

A tenth embodiment is an application of the second embodiment. In the present embodiment, a case in which a printer is connected to the image-data output device 20b and executes an actual size print is explained.

In the case of FIG. 25, the image-data output device 20b stores the resolution of the printer in addition to the dot pitch of the display device 5b. In a similar manner as the dot size of the object image is controlled based on the dot pitch of the display device 5b so that the object image is displayed in actual size on the display device 5b, the dot sizes of the object image and the instruction image data are controlled based on the resolution of the printer. In this case, the display size of the object image becomes the print size. The image-data output device 20b outputs, to the printer, the output image data including the object image and the instruction image data after the control. Since the printer executes a dot-by-dot print, the size of the object image printed by the printer becomes the print size. Whether the instruction image data is included in the output image data is determined by a user selection.

There is a case in which the size of a print sheet is smaller than the print size of the object image. In this case, the image-data output device 20b splits the output image data to be transmitted to the printer. As a result, the object image is split and displayed as shown in FIG. 25. For, example, when the object image is split onto two sheets, preferably, a margin remains on one side of one sheet, and no margin remains on a corresponding side of the other sheet, thereby enabling a user to easily connect the sheets that are split and printed out. By performing the actual-size print in the above manner, and carrying the actual-size print, the user can easily verify whether furniture can be disposed in a room, what it will be lie to dispose a vase on a floor, etc.

### Eleventh Embodiment

An eleventh embodiment is an application of the first embodiment. In the present embodiment, a case in which the image-data output device 20a is a cellular phone, and information viewed on the screen of the cellular phone is transmitted to a TV (display device 5a) according to a user manipulation is explained.

With the use of the cellular phone, access to network is very easy. However, the screen of the cellular phone is very small, and it is hard to display an object in actual size in many cases. Therefore, as shown in FIG. 26, the cellular phone generates, according to a user instruction, the output image data corresponding to the object image displayed on the screen thereof, and transmits the generated output image data to the TV. As a result, the object image is displayed in actual size on the TV screen.

Although the means for transmitting the object image from the cellular phone or a mobile terminal to the display includes wireless LAN, infrared communication, Internet mail, and the like, the means is not limited hereto. The cellular phone may transmit the output image directly to the TV. Alternatively when the object image, the length information, and the display size are stored in a database on the Internet, the cellular phone may transmit the address of the database to the TV so that the TV can acquire the object image, the length information, and the display size by accessing the Internet based on the received address.

Although the embodiments of the present invention are explained, the present invention is not limited to the embodiments, and it is understood that various modifications may be made without departing the scope of the present invention.

For example, although the server device 4 transmits the object image, etc., directly to the image-data output device 20a, etc., in each of the embodiments, a set of the object image, the length information) and the display size may be stored in a database, etc., so that the image-data output device 20a, etc., can acquire the set therefrom.

The aforementioned processing may be executed by storing a program for implementing the functions of the image-data output devices 20a, 20b, and 20c on a computer-readable recording medium by reading the program stored on the recording mediums onto a program memory of a computer system constituting each device and by executing the read program.

The “computer system” may include hardware such as an operating system and a peripheral device. Additionally, when utilizing a WWW system, the “computer system” also includes a homepage providing environment (or display environment).

Additionally, the “computer-readable recording medium” includes a writable nonvolatile memory such as a flexible disk, a magneto-optical disc, a ROM (read-only-memory), a flash memory, a portable medium such as a CD-ROM (compact-disc read-only memory), and a storage device such as a hard disk built in the computer system.

Furthermore, the “computer-readable recording medium” includes a volatile memory (such as a DRAM (dynamic random access memory)) that retains a program for a given period of time and is included in a computer system of a server or a client when the program is transmitted through network such as the Internet, or a telecommunication line such as a telephone line.

Additionally, the program may be transmitted from a computer system that stores the program in a storage device thereof to another computer system through a transmission medium or a carrier wave in the transmission medium. The “transmission medium” that transmits a program is a medium having a function of transmitting information such as network (communication line) such as the Internet or a communication line such as a telephone line.

Moreover, the program may be one for implementing a part of each of the aforementioned functions or a difference file (difference program) that can implement each of the aforementioned functions using a combination of programs already stored in the computer system.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An image-data display system, comprising:
a display-size acquiring unit that acquires a display size of an object image including a plane projection image of a three-dimensional object;
an instruction-image-data acquiring unit that acquires instruction image data indicative of two positions in the plane projection image displayed in the object image, a length between the two positions being actual size when the object image is displayed according to the display size; and
a display device that displays the object image according to the display size, and executes display processing based on the instruction image data.

2. The image-data display system according to claim 1, wherein the instruction image data includes data indicative of an actual size length between the two positions.

3. The image-data display system according to claim 1, wherein the display device enlarges or reduces the object image to the display size.

4. The image-data display system according to claim 1, further comprising
an output-image generating unit that controls a dot size of the object image based on the display size and a dot pitch of a display surface of the display device, wherein
the display device displays the object dot by dot.

5. An image-data output device, comprising:
a display-size acquiring unit that acquires a display size of an object image including a plane projection image of a three-dimensional object;
an instruction-image-data acquiring unit that acquires instruction image data indicative of two positions in the plane projection image displayed in the object image, a length between the two positions being actual size when the object image is displayed according to the display size; and
an output unit that outputs, to a display device, the object image, the instruction image data, and the display size.

6. An image-data output device, comprising:
a display-size acquiring unit that acquires a display size of an object image including a plane projection image of a three-dimensional object;
an instruction-image-data acquiring unit that acquires instruction image data indicative of two positions in the plane projection image displayed in the object image, a length between the two positions being actual size when the object image is displayed according to the display size;
a dot-size control unit that controls a dot size of the object image based on the display size and a dot pitch of a display surface of a display device; and
an output unit that outputs, to the output device, the object image after the control by the dot-size control unit and the instruction image data.

7. An image-data output device, comprising:
a display-size acquiring unit that acquires a display size of an object image including a plane projection image of a three-dimensional object;
an instruction-image-data acquiring unit that acquires instruction image data indicative of two positions in the plane projection image displayed in the object image, a length between the two positions being actual size when the object image is displayed according to the display size;
a dot-size control unit that controls a dot size of the object image based on the display size and a dot pitch of a display surface of a display device;
an output unit that outputs the object image after the control by the dot-size control unit to a first memory, and an instruction image generated based on the instruction image data to a second memory; and
an image combining unit that combines the object image stored in the first memory and the instruction image stored in the second memory.

8. An image-data output device, comprising:
a print-size acquiring unit that acquires a print size of an object image including a plane projection image of a three-dimensional object;
an instruction-image-data acquiring unit that when the object image is displayed according to the print size, acquires instruction image data indicative of two positions in the plane projection image displayed in the object image, a length between the two positions being actual size;
a dot-size control unit that controls a dot size of the object image based on the print size and a resolution of a printer; and
an output unit that outputs, to the printer, the object image after the control by the dot-size control unit, and the instruction image data.

9. An image-data display method, comprising:
acquiring a display size of an object image including a plane projection image of a three-dimensional object;
acquiring instruction image data indicative of two positions in the plane projection image displayed in the object image, a length between the two positions being actual size when the object image is displayed according to the display size;
displaying the object image according to the display size; and
executing display processing based on the instruction image data.

10. A recording medium that stores a program causing a computer to execute:
acquiring a display size of an object image including a plane projection image of a three-dimensional object;
acquiring instruction image data indicative of two positions in the plane projection image displayed in the object image, a length between the two positions being actual size when the object image is displayed according to the display size; and
outputting, to a display device, the object image, the instruction image data, and the display size.

11. A recording medium that stores a program causing a computer to execute:
acquiring a display size of an object image including a plane projection image of a three-dimensional object;
acquiring instruction image data indicative of two positions in the plane projection image displayed in the object image, a length between the two positions being actual size when the object image is displayed according to the display size;
controlling a dot size of the object image based on the display size and a dot pitch of a display surface of a display device; and
outputting, to the display device, the object image after the control by the dot-size control unit and the instruction image data.
